(19) United States
(12) Patent Application Publication
(10) Pub. No.: US 2012/0124168 A1
(43) Pub. Date: May 17, 2012

(54) SERVER MIGRATION METHOD

(76) Inventors: Paul Boerger, Loveland, CO (US); Fred Charles Thomas, Fort Collins, CO (US)

(21) Appl. No.: 13/386,904

(22) PCT Filed: Dec. 18, 2009
(86) PCT No.: PCT/US09/68787

§ 371 Date: Jan. 25, 2012

(51) Int. Cl. G06F 15/16

(52) U.S. Cl. 709/217

(57) ABSTRACT

A method of migrating a legacy server to a new server over a high-speed connection is provided. Programs to effect the migration over the high-speed connection include programs operating to configure the new server as a disk drive to receive file and settings transfer before configuration of the new server as a server.

### BACKGROUND

Migrating files from one server to another can be very time consuming due to the increasing amounts of data and the size of programs that are to be migrated, and the increasing size of storage devices. A full migration of a server to another server can take multiple days.

As with the PC industry, consumers often want or need to upgrade Home Server systems, particularly as storage needs and updated operating systems and programs evolve. Data migration, naming conventions, and network and preference settings can be time-consuming to migrate from one server to another. Further, such migration may introduce many errors. The amount of time and the amount of steps used to migrate a server can be onerous, often taking multiple days.

Server migration is a process by which an server-type operating system as well as all programs, protocols, and other tools, including data and settings, are transferred from one server to another, for example when a server is to be upgraded for purposes of providing additional storage, faster operation, or the like. Typical methods for server migration are step by step, manual migration processes that are slow. In many instances, the only successful way of migrating a server is a drag-and-drop method of manually copying files from the old system to the new system. The overhead of standard network protocols (such as HTTP, TCP/IP, UDP, and SMTP) diminishes network-based transfers to very slow transfer rates.

### DESCRIPTION OF THE DRAWINGS

FIG. 1 is a flow chart diagram of a method according to one embodiment of the present disclosure;

FIG. 2 is a flow chart diagram of a method according to another embodiment of the present disclosure; and

FIG. 3 is a block diagram of a system on which embodiments of the present disclosure may be practiced.

### DETAILED DESCRIPTION

In the following detailed description of the present embodiments, reference is made to the accompanying drawings that form a part hereof, and in which is shown by way of illustration specific embodiments of the disclosure which may be practiced. These embodiments are described in sufficient detail to enable those skilled in the art to practice the subject matter of the disclosure, and it is to be understood that other embodiments may be utilized and that process or mechanical changes may be made without departing from the scope of the present disclosure. The following detailed description is, therefore, not to be taken in a limiting sense, and the scope of the present disclosure is defined by the appended claims and equivalents thereof.

To an average user, setting up server user accounts, linking an old system to a new system, migrating data and transferring server settings (such as router port forwarding, network security settings, and the like) is a tedious, time-consuming, and error-prone process. Many servers used for home use ship today with on the order of one terabyte (1 TB) of storage. As increasing use is made of storage-intensive files, such as high-quality digital audio files, and especially video files, storage requirements will similarly increase. As future capacity requirements are realized, migration of older servers to newer, faster servers with more storage will be a more common occurrence. Average transfer rates for traditional network based protocols are approximately 20 gigabytes (GB) per hour, and migration of preferences, server settings, naming nomenclatures, shares, and the like are traditionally done manually. Migrating 1 TB of data at standard rates means on the order of 50 hours of transfer time. Over 50 hours, the likelihood of errors or the like increases simply due to the amount of time and constant activity involved. Therefore, upgrading a home server or offloading processes via a high-bandwidth low overhead interface is not currently feasible.

Embodiments of the present invention connect a high-bandwidth peripheral interface such as 1394 (FireWire), USB, or eSATA between servers. Upgrades and data migration are managed automatically over the high-bandwidth connection, using software, firmware, hardware, or combinations thereof using storage-level protocol interfaces which are much faster and more efficient than network protocol layered communications.

Direct cabling in one embodiment allows re-purposing of a high-speed interface (such as 1394, eSATA, or USB), to arbitrate migration (such as mirroring via synchronized application modes), migrate data (such as directory structures, folders, files), and/or synchronize preferences (such as backup times, client information, display settings).

The embodiments of the present invention allow a reduced amount of time and energy to migrate servers. Data can be moved on the order of 10 or more times faster than over a network protocol; client migration dependencies can be reduced or removed; errors in settings migration, client server interfaces, and backup profiles can be reduced; omissions and/or lost files can be reduced; renaming convention migration can be made easier; remote access configurations can be performed seamlessly to the user; and the like.

In one embodiment, a method of migrating a home server to a new home server includes loading a program to perform a push of data from the legacy server to the new server on the legacy server in block 102, connecting the home and the new home servers via a high-speed connection in block 104, configuring the home server as a source for the new home server in block 106, configuring the new home server to act as a disk drive for the home server in block 108, migrating the legacy server to the new server using the migration program in block 110, and resetting the new server as an active server when the migration is completed in block 112.

In one embodiment, a complete migration sequence works as follows. A new server is purchased. Migration software, including instructions for migrating from a legacy or existing server to the new server, is loaded or pre-loaded on the new server. A migration program allowing the existing, or legacy, server to operate to push files to the new server is loaded onto the existing server. A high-bandwidth connection is made between the new server and the legacy server, and the migration program is executed.

In one embodiment, the program identifies the legacy server as a source for the new server, and the new server is configured via the high-bandwidth connection (for example eSATA, USB, 1394, or the like) to act as a disk drive for receipt of the old server settings and data. The migration program in one embodiment repurposes the high-speed connection port that is used for the connection between the new server and the legacy server to push the migration to the new server when it identifies, via port checking or the like, that the new server is connected via the high-bandwidth connection to the legacy server, identifies the new server as a new server, and sees that the new server is set up as a disk drive. This is all performed by the programs on the old server and the new server, which function together to automate the migration of settings, data, and the like to the new server.

Transfer is automated to transfer settings, protocols, data, network settings, and the like over the high-speed connection from the legacy server to the new server. Once the new server has all the data and settings from the legacy server migrated to the new server, the new server stops acting as a disk drive, and begins to act as a server. Then, in one embodiment, the legacy server is converted to a storage device for the new server.

Migration of certain server-specific types of data, content, and information are also provided in various embodiments. Examples of such data, content, and information that are migrated include, by way of example and not by way of limitation, security settings, user settings, and system settings.

Security settings that are migrated from the legacy server to the new server include security policies; digital rights management (DRM) security information; security certificates; tokens; encryption keys such as those for file systems, applications, individual files, and the like. For example, if the legacy server has content or data thereon that is protected by DRM, is encrypted, or has other security settings, or if the entire system is encrypted, those encrypted settings, data, and content are migrated intact, and any permissions associated with file usage or the like are also transferred to the new server.

User settings that are migrated from the legacy server to the new server include user policies such as user and administrator login information, user and administrator password information, credentials, user accounts and rights, storage policies, user permissions, and the like. For example, servers may contain information on many accounts with individual permissions and policies. Such information is migrated intact, and transferred to the new server.

System settings that are migrated from the legacy server to the new sever include settings such as sleep/wake schedules, backup schedules and settings, add-ins, email (such as email server settings and mailbox and exchange settings), system health, and the like. For system health, which may include, by way of example only and not by way of limitation, temperature reporting, fan speed, general purpose input/output (GPIO) settings and devices, LED dimming and the like, such settings are migrated intact, and transferred to the new server. In some instances, system health settings, while transferred to the new server, may also be retained on the legacy server to allow monitoring of all or some of the same types of health settings on the legacy server when it is used as a storage device, or as a system to off-load certain tasks such as are described below.

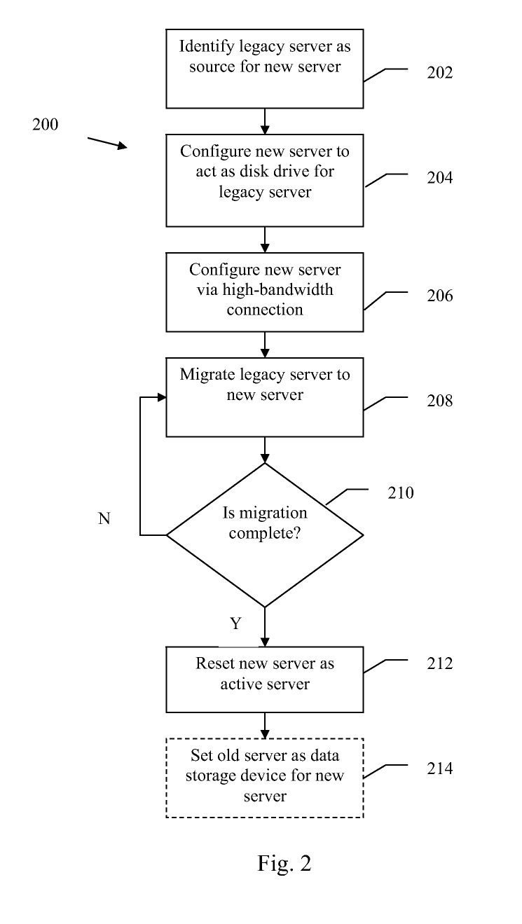

A method 200 for operation of the migration program is shown in greater detail in FIG. 2. Method 200 comprises identifying the legacy server as a source for the new server in block 202, and configuring the new server via the high-bandwidth connection in block 204. The high-bandwidth connection can be a connection such as eSATA, USB, 1394, or the like. The program configures the new server to act as a disk drive for receipt of the old server settings and data in block 206. Migration of data, settings, and the like is pushed to the new server in block 208. Programs on the legacy server and the new server function together to automate the migration of settings, data, and the like to the new server.

Once migration is complete as determined in decision block 210, the migration program sets the new server to act as a server instead of a disk drive in block 212. Optionally, the legacy server is set to act as a data storage device for the new server in block 214.

Once a home server is migrated to a new home server, such as by the process described above, there is no easy method for offloading processes so that more efficient operation can occur. In another embodiment, a high-bandwidth interconnection between the old home server and the new home server offloads high-CPU-utilization processes such as transcoding, virus/malware scanning, and the like to utilize the functionality and additional storage of legacy systems such as old home servers that have been migrated to new home servers. The operation can work in both directions of communication. For example, a legacy server can continue to operate main components of the system, but can offload high-CPU-utilization or memory-intensive functions to a new server.

The various embodiments of the present disclosure are provided for the purposes of efficiently migrating an old server, with all of its settings, protocols, data, programs, and network settings, to a new server via a high-speed connection. Protocols and programs for effecting the migration are used on both the new server and the legacy server to streamline the migration, and to set up the legacy server as a storage device for the new server once migration is complete.

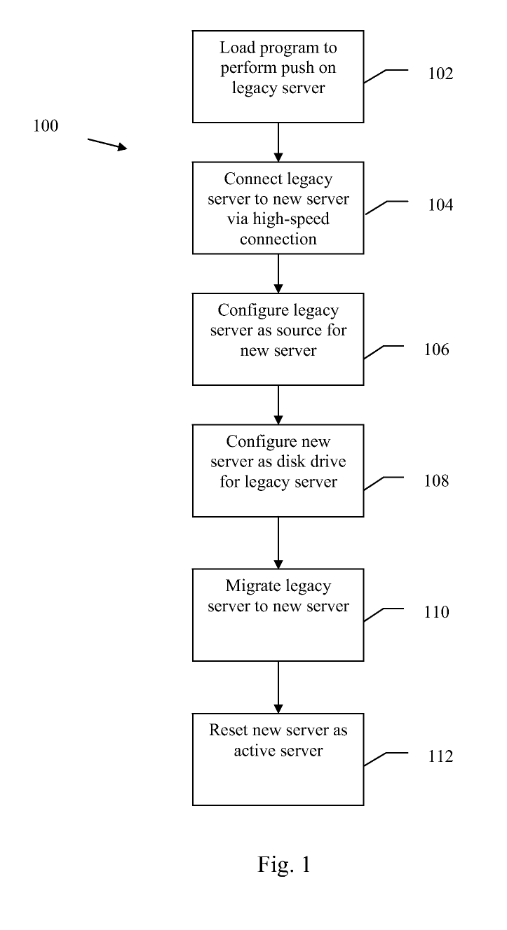

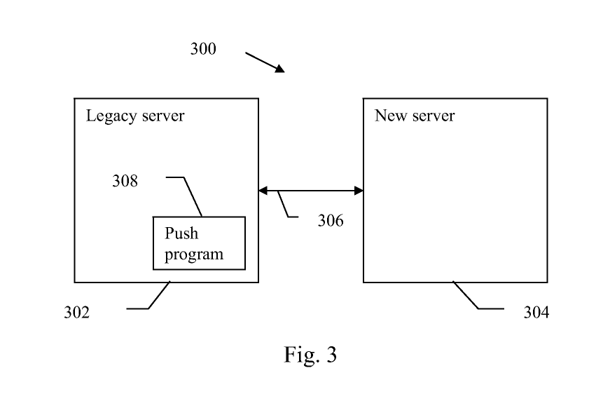

FIG. 3 is a block diagram showing a system 300 on which embodiments of the present disclosure may be practiced. System 300 includes a legacy server 302 and a new server 304 connected by a high-speed connection 306. A program 308 such as those described above with respect to FIGS. 1 and 2 is loaded into memory (not shown) of the legacy server to migrate data (including program files, network settings, security settings, program data, and the like) from the legacy server 302 to the new server 304 via the high-speed connection 306. In another embodiment, a similar program to configure operation of the new server 304 may be loaded into memory of the new server 304.

Various embodiments of the present disclosure may be embodied in a computer program product, which may include computer readable program code embodied thereon, the code executable to implement a method such as the methods described herein for backing up a backup space. The computer readable program code may take the form of computer-readable instructions. These computer-readable instructions may be stored in a memory, such as a computer-usable medium, and may be in the form of software, firmware, hardware, or a combination thereof. The computer-readable instructions configure a computer to perform various methods, such as described below in conjunction with various embodiments of the invention.

In a hardware solution, the computer-readable instructions are hard coded as part of a processor, e.g., an application-specific integrated circuit (ASIC) chip. In a software or firmware solution, the instructions are stored for retrieval by the processor. Some additional examples of computer-usable media include static or dynamic random access memory (SRAM or DRAM), read-only memory (ROM), electrically erasable programmable ROM (EEPROM or flash memory), magnetic media and optical media, whether permanent or removable. Most consumer-oriented computer applications are software solutions provided to the user on some form of removable computer-usable media, such as a compact disc read-only memory (CD-ROM) or digital video disc (DVD). Alternatively, such computer applications may be delivered electronically, such as via the Internet or the like.

It will be appreciated that embodiments of the present invention can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

What is claimed is:

1. A method of migrating a legacy server to a new server, comprising:
loading a push program to the legacy server;
connecting the legacy server and the new server via a high-speed connection;
configuring the legacy server as a source for the new server;
configuring the new server to act as a disk drive for the legacy server; and
transferring the legacy server to the new server using the push program.

2. The method of claim 1, wherein configuring is accomplished by the push program when a high speed connection is verified between the legacy server and the new server.

3. The method of claim 1, wherein the legacy server is configured by the software loaded thereon to push files via the high-speed connection to the new server.

4. The method of claim 1, wherein transferring the legacy server to the new server further comprises reserving at least a portion of server functions to the legacy server.

5. The method of claim 4 wherein reserving further comprises reserving at least one of transcoding, virus scanning, and malware scanning

6. The method of claim 1, wherein transferring the legacy server to the new server further comprises transferring at least one of security settings, user settings, and system settings.

7. A method of operating a migration from a legacy server to a new server, comprising:
identifying the legacy server as a source for the new server;
configuring the new server to act as a disk drive for the legacy server; and
configuring the new server via a high-bandwidth connection between the legacy server and the new server.

8. A method according to either of claim 1 or 7, and further comprising:
resetting the new server as an active server after migration.

9. A method according to either of claim 1 or 7, and further comprising:
configuring the legacy server as a data storage device for the new server when migration is complete.

10. The method of claim 7, wherein configuring further comprises pushing data from the legacy server to the new server.

11. The method of claim 7, wherein pushing data further comprises pushing at least one of security settings, user settings, and system settings.

12. A method according to either of claim 1 or 7, and further comprising:
offloading a portion of CPU utilization processes from the new server to the legacy server.

13. The method of claim 12, wherein offloading further comprises offloading at least one of transcoding, virus scanning, and malware scanning

14. A server migration system, comprising:
a new server; and
a migration program to load on a legacy server, the migration program comprising machine-readable instructions for causing a computer to perform a method for migrating a legacy server to the new server, the migration program configured to cause a legacy computer to migrate data to the new server.

15. The system of claim 14, wherein the migration program is further configured to identify the legacy server as a source for the new server, configure the new server to act as a disk drive for the legacy server, configure the new server via a high-bandwidth connection between the legacy server and the new server, and set the new server to act as a server instead of a disk drive once migration is complete.
